(19) United States
(12) Patent Application Publication
(10) Pub. No.: US 2025/0130921 A1
(43) Pub. Date: Apr. 24, 2025

(54) METHOD FOR VERIFYING STATIC WARNINGS OF LLM-GENERATED CODE WITH DIRECTED FUZZING

(71) Applicant: Robert Bosch GmbH, Stuttgart (DE)

(72) Inventors: Christopher Huth, Heilbronn (DE); Jesko Hecking-Harbusch, Leonberg (DE); Jochen Quante, Ludwigsburg (DE); Matthias Woehrle, Bietigheim-Bissingen (DE); Maximilian Schlund, Stuttgart (DE); Sebastian Ernesto Sierra Loaiza, Stuttgart (DE)

(21) Appl. No.: 18/917,234

(22) Filed: Oct. 16, 2024

(30) Foreign Application Priority Data
Oct. 19, 2023 (EP) 23204628.4

(51) Int. Cl. G06F 11/36

(52) U.S. Cl. CPC G06F 11/3612; G06F 11/3644

(57) ABSTRACT

A method for verifying static warnings of code generated by a language model includes (i) providing an executable file from a program code generated by a language model, (ii) providing warning points in the program code originating from static testing, (iii) performing directed fuzzing by a fuzzer, wherein the fuzzer injects inputs into the executable file to reach a warning point, (iv) monitoring the behavior and output of the executable file, and (v) rating the warning point based on the behavior and the output.

This application claims priority under 35 U.S.C. § 119 to patent application no. EP 23204628.4, filed on Oct. 19, 2023 in Europe, the disclosure of which is incorporated herein by reference in its entirety.

### BACKGROUND

Increasingly, program code is generated with language models such as Large Language Models (LLMs). This may occur, for example, in the context of a language translation or automated program code translation or code refactoring.

For example, using automated code generation approaches from LLMs always presents challenges, so there is no guarantee of the correctness of the code and no guarantee of performance improvements. For example, improvements can be generated for small code fragments, but this approach is not practical for larger code bases.

Working with larger code bases degrades the usability of certain static methods, e.g. the abstract interpretation, because correctness guarantees cannot be calculated in an appropriate time or an approximation is required, which then leads to over-approximation errors. In addition, static methods are hardly suitable to measure software performance, e.g. the run time.

The biggest drawback of static methods that are “sound” (i.e., guaranteed to miss nothing), especially when introduced to a software project for the first time, is that a variety of warnings appear, all of which must be fixed or marked as a false positive. This cannot be prevented by the static method itself, otherwise it would lose its soundness (100% recall).

### SUMMARY

A first general aspect of the present disclosure relates to a method for verifying static warnings of code generated by a language model.

The method includes
providing an executable file from a program code generated by a language model,
providing warning points in the program code originating from static testing,
performing directed fuzzing through a fuzzer, wherein the fuzzer injects inputs into the executable file to reach a warning point,
monitoring the behavior and output of the executable file,
rating the warning point based on behavior and output.
   A second general aspect of the present disclosure relates to a method for training a language model set up to automatically generate program code.

The method includes
entering a source code into a language model and generating a program code,
verifying the program code with the method according to the first general aspect,
generating a reward for the language model, wherein the reward is based on the rating of the warning point based on the behavior and the output,
updating weights of the language model with the value of the reward.

A third general aspect of the present disclosure relates to a computer system configured to carry out the method according to the first and/or the second general aspect (or an embodiment thereof).

A fourth general aspect of the present disclosure relates to a computer program configured to carry out the method according to the first general aspect (or an embodiment thereof).

A fifth general aspect of the present disclosure relates to a computer-readable medium or signal, which stores and/or contains the computer program according to the fourth general aspect (or an embodiment thereof).

The techniques of the first, second, third, fourth and fifth general aspects may have one or more of the following advantages in some situations.

The present disclosure uses directed fuzzing to validate warnings from static code analysis, thereby solving one of the biggest drawbacks of static analysis, namely, the sheer amount of warnings. This allows these warnings to be processed or dynamically checked automatically, saving a lot of manual work.

The present disclosure makes it possible to avoid existing testing, namely unit testing, among other things, to verify whether the generated code patches are functionally correct, as fuzzing is used here. In reality, unit testing does not cover all cases of the software, and in some cases unit testing is not available at all.

Typically, warnings generated by static methods need to be addressed by tremendous manual work. Fuzzing according to the present disclosure is well-suited for unmasking warnings as true positive messages, which in turn must be primarily treated.

The present disclosure enables, by targeted fuzzing, the computational testing effort or focus of a test run to direct code points with a warning. This saves time and energy compared to a general search-based fuzzing.

The present disclosure enables coverage as a quality scale for generated code, which in turn allows for the selection of better generated code. Such higher quality code is then easier to test.

A method or system is proposed that continuously generates code, verifies that code, subjects it to directed fuzzing and (with a feedback loop) improves further generations of generated code.

The present disclosure is relevant to any product that is based on automated testing, particularly dynamic testing methods, and any product that has legacy code or performance problems.

Some terms are used in the present disclosure in the following manner:

A “language model” can in particular be a large language model (LLM), a neural network, a recurrent neural network (RNN), a transformer model, or a code model as a language model specialized for code or also a very general language model that also includes code. Also included are computer languages, codes such as program codes of a computing device such as a computer. The language of the model can include not only natural languages, but also artificial languages such as programming languages.

“Refactoring” code in software development means structural improvements to code while maintaining the observable program behavior, i.e. functionality. For example, readability, comprehensibility, maintainability and/or extensibility should be improved with the aim of reducing the respective effort for error analysis and/or functional extensions. Typical refactoring includes, for example, renaming variables into self-explanatory names and/or extracting code parts into separate methods. Refactoring increases the quality of the code, hence the software.

“Testing,” “checking” or “comparing the source program code and the target program code” can include: a formal check of the same behavior of the source program code and the target program code, for example by way of bounded model checking, tests in the source language, tests for contracts in the source language and/or syntactic and stylistic tests, fuzzing, mutation of the inputs of the test harness, derivation from contracts of the source language and/or the target language and/or derivation from a language model.

A “test harness” or test framework includes a collection of software and test data that is used to systematically and automatically test a program under different ambient conditions. A test harness typically includes a test execution engine that is responsible for executing the test logic, and a test data repository or database that contains the test scripts, test programs and other test resources. The test harness in this case is generated automatically, for example by adding differentiating tests to the database. The test can be started with specific or ready-made tests from the test database. The system can also generate tests automatically.

Data here can be software code including test cases and harnesses plus additional (natural language) descriptions of the functionality or areas of validity. In the case of language translation, as an example, C is described here as the source language and Rust as the target language, but other combinations are also possible. The translation of C to Rust is interesting, because Rust provides features in the area of security-critical systems, whereas other languages, especially C, include a lot of legacy code. In the case of refactoring, the source and target languages are the same.

“Contracts” are a component of contract-based programming or design by contract. This is a concept of software development that has the objective of optimizing the interaction of individual program modules by defining formal contracts for the use of interfaces that go beyond their static definition.

The term “codebase” refers to all source code files associated with a project, as well as any associated configuration files. The codebase may also include various other files that are required for the process of compiling, e.g. so-called makefiles.

“Fuzzing” or “fuzz testing” is the automated process of sending randomly generated inputs from a fuzzer to a target or target program and observing the response of the target.

A “fuzzer” or “fuzzing engine” is a program that automatically generates inputs. They are therefore not necessarily connected to the software being tested and no instrumentation is carried out. They do, however, have the ability to instrument code, generate test cases and execute programs being tested. Well-known examples are afl and libfuzzer.

A fuzz target is a software program or a function that is to be tested by way of fuzzing. A key feature of a fuzz target is that it is a binary file, library, application programming interface (API), or something else that can process bytes as input.

“Glue codes”, “wrappers”, “harnesses” or “fuzz drivers” connect a fuzzer to a fuzz target.

A fuzz test is the combined version of a fuzzer and a fuzz target. A fuzz target may then be instrumented code with a fuzzer connected to its inputs. A fuzz test is executable. The fuzzer can also start, observe and stop multiple running fuzz tests (generally hundreds or thousands per second), each with a slightly different input generated by the fuzzer.

A “test case” is a specific input and a specific test run from a test harness or fuzz test. To ensure reproducibility, interesting runs (finding new code paths or crashes) are stored.

“Instrumentation” is used to make the coverage metric observable, e.g. during the compilation. Instrumentation is the insertion of instructions into a program in order to obtain feedback on the execution. The latter is usually performed by the compiler and can, e.g., describe the code blocks achieved during execution.

Coverage-guided fuzzing uses code coverage information as feedback during fuzzing, in order to detect whether an input has caused the execution of new code paths/blocks.

In “mutation-based fuzzing,” new inputs are created by using a series of known inputs (corpus) and randomly applying mutations to them.

In “generation-based fuzzing,” new inputs are created from scratch, e.g. by using input models or input grammars.

“Mutator” is a function that takes bytes as input and outputs a small random mutation of the input.

A “corpus” (plural: corpora) is a set of inputs. Initial inputs are seeds.

### BRIEF DESCRIPTION OF THE DRAWINGS

FIG. 1 is a flow chart illustrating the techniques of the present disclosure for verifying static warnings.

FIG. 2 schematically shows a system in which the techniques of the present disclosure for verifying static warnings can be used.

FIG. 3 schematically illustrates a fuzzing system in which the techniques of the present disclosure may be employed to verify static warnings.

FIG. 4 schematically illustrates a system in which the techniques of the present disclosure may be employed to verify static warnings.

FIG. 5 is a flow chart that illustrates the techniques of the present disclosure for training a language model.

### DETAILED DESCRIPTION

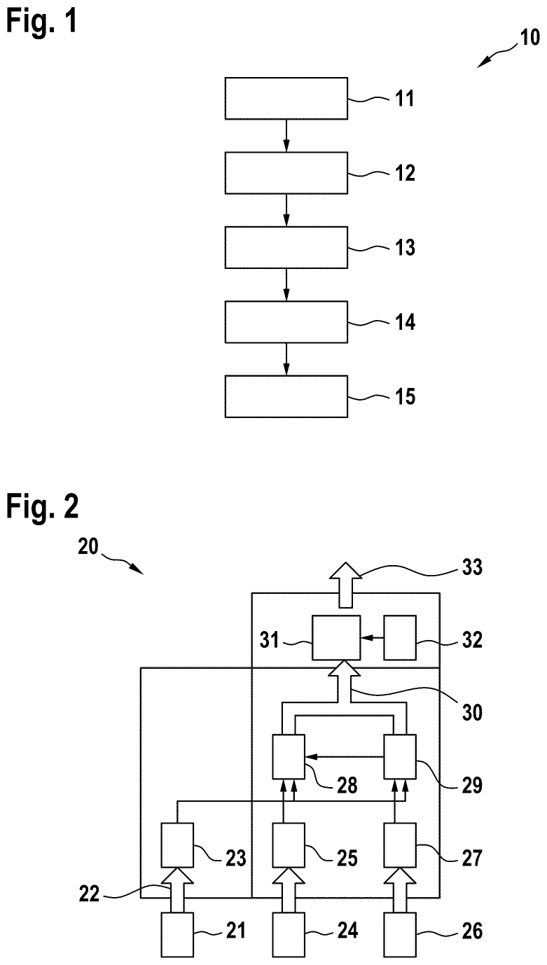

FIG. 1 is a flow chart depicting a method 10 for verifying static warnings of code generated by a language model. The generated code is generated according to FIG. 1 in an automated program code translation from an original language to a target language. Alternatively, the program code may be generated by code refactoring.

The method 10 proposed in this disclosure is directed to verify static warnings of software code generated by a language model. The software may be configured to control, regulate and/or monitor a technical system, in particular a cyber-physical system, in particular at least one computing unit of a vehicle. In particular, the software may be an embedded software that is designed to execute on an embedded (i.e., task-specific) system.

In a first step, an executable file is provided 11 from a program code generated by a language model. The provision includes only the input of a program code or a file already compiled in the method or the system and the inclusion of the generation or the language model in the method or the system. The provision may further comprise, for example, a fuzzer instrumenting the program code for directed fuzzing. Verification of static warnings or directed fuzzing may run asynchronously to program code generation and may also run continuously. Alternatively, the fuzzing can also be started after the static checks. If the language model generates the first code, or if there are newer versions, the executable file is compiled and instrumented for targeted fuzzing.

Providing 12 warning points in the program code originating from static tests occurs. For example, static testing or checks may include:
Contracts are either specified or extracted from the system environment.
In the case of Rust, static checks can also be provided by the compiler; in other languages, e.g. also by Linter etc.
Bounded model checking and/or abstract interpretation, implemented in commercial tools such as Astrée or open source tools such as CBMC.
Automatic configuration of a bounded model checking setup that statically compares target program code against given contracts.
Automatic configuration of an abstract interpretation setup that statically compares target program code against given contracts.
Automatic configuration of a bounded model checking setup that checks source program code and target program code for functional equality.

These two provisions may occur in parallel or in any order. Dynamic operations are also possible in which the provisions are partially updated.

Performing 13 of directed fuzzing by a fuzzer follows, wherein the fuzzer injects inputs into the executable file to reach a warning point. Directed fuzzing can be used in a gray box environment, so that lightweight observations can guide the fuzzing. A blackbox setting is also possible (e.g., debugger-controlled fuzzing) but may be less performant.

In other words, the fuzzer attempts to generate inputs to the executable file to reach a warning point selected from the amount of warning points generated by static tests or checks.

Monitoring 14 of the behavior and output of the program code follows. In doing so, for example, inconsistencies, poorer run time behavior or bugs are detected. The behavior of the program code may comprise the actual run time per test case.

Then, the warning point is rated 15 based on the behavior and the output. The rating may be made as follows:

If the warning point is not reached within an appropriate test interval, e.g. by a fixed time-out or other coverage, then the warning should receive a low score. A low rating indicates that the warning point is difficult to reach in a dynamic environment.

Whenever the warning point is reached and a reasonable number of test cases triggers that warning point, the warning should receive a low rating. A low rating indicates that the warning point is difficult to trigger in a dynamic environment. This need not be a guarantee of the absence of errors.

Whenever the warning point is reached and an error is found at that warning point, the warning receives a high score. A high rating indicates that the warning point is a real positive finding with a very high probability. Sanitizers such as address sanitizers or memory sanitizers can make more bugs visible to the fuzzer.

In all other cases, the default rating for warning points may be medium.

In accordance with one embodiment, the method further comprises providing a corpus with inputs for the fuzzer that contains initial test cases from code repositories of the program code and/or from provided tests and test harnesses.

According to one embodiment, the method further comprises a low rating being given if the warning point is not reached during fuzzing and/or if the warning point is reached during fuzzing but no error is found there, wherein a high rating is given when the warning point is reached during fuzzing and an error is found there.

According to one embodiment, the method further comprises the program code being output when monitoring has not resulted in any abnormalities, and otherwise generating an output comprising static test warnings with the rating.

The output may then be an ordered list (or a labeled set) of static test warnings with their respective priority. If the fuzzing did not find any inconsistencies, poorer run time behavior or bugs, the generated code is output. The fuzzing may also be ended when all warning points have been attempted or when a pre-determined period of time has been exceeded.

According to one embodiment, the method further comprises feeding the behavior of the executable file, the output of the executable file and/or the rating of the warning point back to the fuzzer.

According to one embodiment, the method further comprises updating the program code or portions of the program code using the behavior of the program code, the output of the program code and/or the rating of the warning point and optionally feeding back the updated program code as an input to the language model.

As an alternative to the described translation, a refactoring of the program code may be provided. Refactoring the program code may include or be changing the program code. The refactored program code may also again be a code of the software, in particular a source code of the software.

FIG. 2 schematically illustrates a computer system 20 in which the techniques of the present disclosure may be employed to verify static warnings of code generated by a language model. The computer system 20 is configured to carry out the method 10 according to FIG. 1 and the method 50 according to FIG. 5. Computer system 20 can be implemented in hardware and/or software. The system shown in FIG. 2 can therefore be considered a computer program that is configured to carry out the method 10 according to FIG. 1 and the method 50 according to FIG. 5.

A source program code 21 in a source language such as C is provided to a language model 22 such as a large language model (LLM) for translation into a target language such as Rust. The language model 22 generates a (target) program code 23 as a translation of the source program code 21. This region of the computer system 20 can be referred to as the generation region.

The language model is a large language model (LLM), for example, into which data such as, in this case, a program code is entered via input (prompt) together with a question, such as, in this case. a translation request or refractory request.

Tests and optionally a test harness in the source language are another input 24 to the system 20. Alternatively or optionally, the tests and/or the test harness can be in the target language. These inputs are fed to a test harness 25. The test harness 25 records functions or tests in the target language.

Optionally, static testing, quality assessments and/or contracts 26 may be provided to a static testing unit 27. These are managed there for later checks of the program code 23.

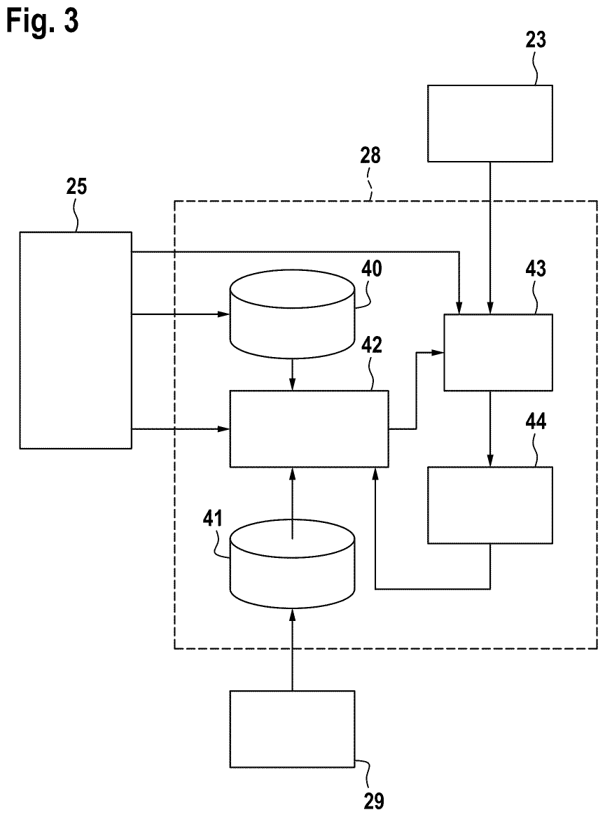

Inputs of a fuzzer 28 for directed fuzzing are connected to the language model 22 for inputting the program code 23 and to the test harness 25 for inputting test routines. In the fuzzer 28, program code 23 is tested based on the test harness 25 with the source program code 21; in particular, static warnings are verified. The fuzzer 28 and its function are described in more detail in connection with FIG. 3.

The generation of the program code 23 by the language model 22 can take place repeatedly with changed conditions, such as changing one or more hyperparameters such as a temperature parameter of the language model, transformations in the source program code and/or changes in the input to the language model such as changes in the tasks or prompts. Variables in the code can be renamed as well.

These measures create a variance. This variance makes it possible to verify and improve the quality evaluation of the generated translations and also train the language model with feedback. Part of the improved quality assessment is being able to determine which of the generated program codes 23 are more or less suitable. The fuzzer 28 then works with these variations of program codes 23.

Inputs of a checking unit 29 are connected to the language model 22 for inputting the program code 23 and to the static test unit 27 for inputting static tests, quality assessments and/or contracts 26. In the second checking unit 29, the program code 21 is checked using the static tests, quality assessments and/or contracts 26.

If the checks in the fuzzer 28 and in the checking unit 29 are completed successfully, a status message 30 indicating that the program code 23 is okay is output. This region of the computer system 20 can be referred to as the checking region.

The target program code 31 can be evaluated in terms of its quality using metrics 32. The metrics 32 can include code quality metrics, test quality metrics and/or the number of tests. If the evaluation is successful, the program code and its quality are output as the output 33. This region of the computer system 20 can be referred to as the quality evaluation region.

A quality can be calculated on the basis of the evaluation. If several target program codes have been generated, the solutions can be provided to the user in order of quality.

The program code can be rated, for example, based on code quality metrics such as the length of the source code, the number of loops and/or the branch depth, test quality metrics such as branch coverage and/or number of available or carried out tests.

FIG. 3 shows the fuzzer 28 in detail as well as the test harness 25, the verification unit 29 and the program code 23 as inputs for the fuzzer 28.

For the targeted fuzzing verification or check, the fuzzer 28 includes the following parts. A corpus 40 is filled with initial test cases from the code repositories (which are translated or refactorized) and/or from the provided tests and test harnesses. For this purpose, the corpus 40 is connected to the test harness 25.

Warning locations or warning points 41 are stored and provide the destination in the program code that the fuzzer 42 is to reach. Warning points 41 originate from the checking unit 29.

The fuzzer 42 takes generated code as input, e.g. for instrumentation. For this purpose, the fuzzer 42 is connected to the test harness 25. However, the main task of the fuzzer 42 is to generate inputs and inject them into an executable file 43. The compiled or executable file 43 is generated from program code 23.

A monitoring unit 44 measures or monitors the coverage of the code during run time, typically in a gray box setting. This is then stored in the monitoring unit 44. The monitoring is a collection of run time behaviors, e.g. the actual run time per test case and outputs of the executable file 43. All of this is returned to the fuzzer 42 to create better test cases.

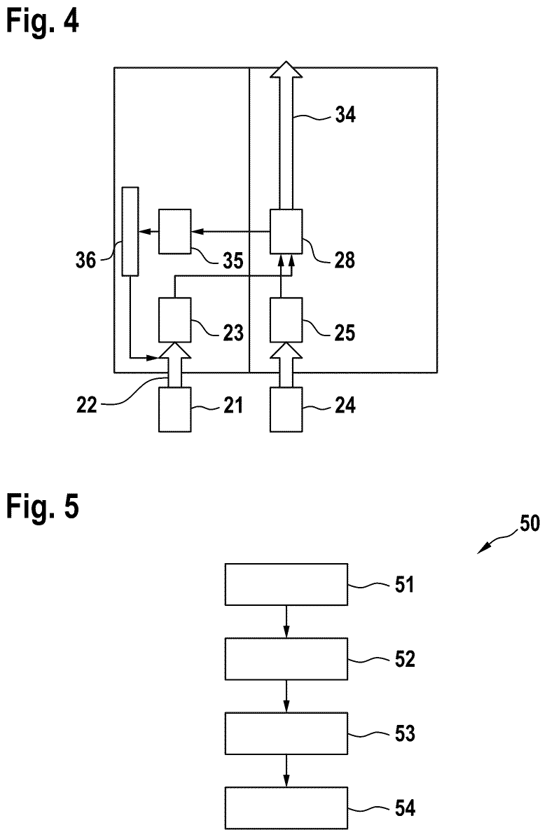

FIG. 4 schematically illustrates a computer system 20 in which the techniques of the present disclosure may be employed to verify static warnings. The computer system 20 can be the same as the computer system 20 of FIG. 2. The computer system 20 is configured to carry out the method 10 according to FIG. 1 and the method 50 according to FIG. 5; the computer system 20 of FIG. 3 is in particular configured to carry out the training method 50 according to FIG. 5. Computer system 20 can be implemented in hardware and/or software. The system shown in FIG. 3 can therefore be considered a computer program that is configured to carry out the method 10 according to FIG. 1 and the method 50 according to FIG. 5.

FIG. 4 shows an error handling mechanism of the computer system 20. If no program code 31 without errors can be generated, an error results in the fuzzer 28. A message 34 to reduce confidence in the translation is then output. The error and the associated program code 31 are moreover stored in an error module 35.

From the error module 35, the best program code to date with the errors that still exist is fed back to the language model 22 as information 36 to be used to generate a better, ideally error-free target program code. This reduces the reliability and is taken into account in the quality determination.

This can optionally refer not only to errors in the checking region, but analogously also to errors in the quality evaluation region.

FIG. 5 is a flow chart that illustrates a method 50 for training a language model. The language model is configured to automatically generate program code.

In summary, the code generated by the language model is returned to the language model as feedback to generate a new generation of source code. The idea is that already suitable (or better) code can then be fine-tuned with an updated input prompt containing the new code in view of the monitoring and behavioral output. For example, if good code only has run time issues at certain points, those points may be returned to the language model.

In a first step of the method, the source program code or source code is input 51 into a language model and program code is generated. The language model can already be pretrained and possibly also already fine-tuned. Alternatively, it is also possible to start with a new, untrained language model. The training here is based on reinforcement learning. Training takes place in a training environment, for example with PPO (proximal policy optimization).

Furthermore, verifying 52 the program code of the predictive target program code is performed using method 10 as previously described using FIG. 1.

Then, a reward for the language model is generated 53, wherein the reward is based on rating the warning point based on the behavior and output from method 10. Thus, a low rating can be made if the warning point is not reached during fuzzing and/or if the warning point is reached during fuzzing but no error is found there. A high rating can be given when the warning point is reached during fuzzing and an error is found there.

Lastly, weights of the language model are updated 54 with the value of the reward. The result of the method is a language model that is better trained on new unlabeled data (here, for example C code from an engine control system), i.e. provides more reliable translations.

According to one embodiment, the method also includes approximating the reward by carrying out only one test of the automatic checking tests. This makes it possible to accelerate the training.

What is claimed is:

1. A method for verifying static warnings of code generated by a language model, comprising:
providing an executable file from a program code generated by a language model;
providing warning points in the program code originating from static testing;
performing directed fuzzing by a fuzzer, wherein the fuzzer injects inputs into the executable file to reach a warning point;
monitoring the behavior and output of the executable file; and
rating the warning point based on the behavior and the output.

2. The method according to claim 1, wherein the program code for directed fuzzing is instrumented.

3. The method according to claim 1, wherein a corpus is provided with inputs for the fuzzer containing initial test cases from code repositories of the program code and/or from provided tests and test harnesses.

4. The method according to claim 1, wherein the behavior of the executable file comprises the actual run time per test case.

5. The method according to claim 1, wherein a low rating is given if the warning point is not reached during fuzzing and/or if the warning point is reached during fuzzing but no error is found there, and wherein a high rating is given when the warning point is reached during fuzzing and an error is found there.

6. The method according to claim 1, wherein the program code is output when the monitoring has resulted in no abnormalities, and wherein otherwise an output is generated that comprises static check warnings with the rating.

7. The method according to claim 1, wherein the behavior of the executable file, the output of the executable file and/or the rating of the warning point is returned to the fuzzer.

8. The method according to claim 1, wherein the program code or portions of the program code is updated using the behavior of the program code, the output of the program code and/or the rating of the warning point, and wherein the updated program code is optionally returned as an input to the language model.

9. A method for training a language model for automatically generating program code, comprising:
entering a source code into a language model and generating a program code;
verifying the program code with the method according to claim 1;
generating a reward for the language model, wherein the reward is based on the rating of the warning point based on the behavior and the output; and
updating weights of the language model with the value of the reward.

10. The method according to claim 9, wherein the reward is approximated by performing only one verification.

11. A computer system configured to carry out the method according to claim 1.

12. A computer program configured to carry out the method according to claim 1.

13. A computer-readable medium or signal storing and/or containing the computer program according to claim 12.
